(19) United States
(12) Patent Application Publication
(10) Pub. No.: US 2026/0103610 A1
(43) Pub. Date: Apr. 16, 2026

(54) METHOD OF PREPARING A POLYMER CAPACITOR, A CONDUCTIVE POLYMER COMPOSITION, AND ITS USE AS A CONDUCTIVE LAYER IN AN ELECTRONIC DEVICE

(71) Applicant: Agfa-Gevaert NV, Mortsel (BE)

(72) Inventors: Roald Herckens, Mortsel (BE); Johan Loccufier, Mortsel (BE)

(73) Assignee: Agfa-Gevaert NV, Mortsel (BE)

(21) Appl. No.: 19/111,165

(22) PCT Filed: Aug. 28, 2023
(86) PCT No.: PCT/EP2023/073508

§ 371 Date: Mar. 12, 2025

(30) Foreign Application Priority Data
Sep. 1, 2022 (EP) 22193384.9

(51) Int. Cl. C09D 5/24; C09D 7/63; C09D 125/18; C09D 165/00; H01G 9/00; H01G 9/025; H01G 9/048

(52) U.S. Cl. CPC C09D 5/24; C09D 7/63; C09D 125/18; C09D 165/00; H01G 9/0036; H01G 9/025; H01G 9/048

(57) ABSTRACT

A method of preparing a polymer capacitor comprising a porous anode body including the step of introducing a conductive polymer formulation into at least part of the porous anode body, the conductive polymer dispersion including at least one oligo- or polythiophene and a polymeric polyanion characterised in that the polymeric polyanion has a polydispersity of 3 or less and a weight average molecular weight (Mw) of 25 to 175 kDa.

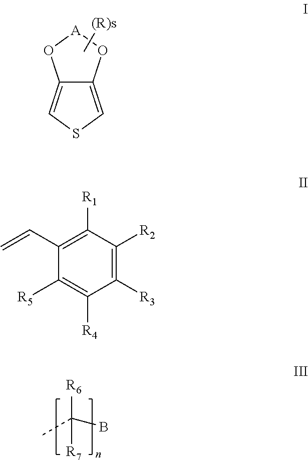

### TECHNICAL FIELD OF THE INVENTION

The present invention relates to a method of preparing a polymer capacitor and to polythiophene/polyanion compositions used therein.

### BACKGROUND ART FOR THE INVENTION

Environmental concerns over greenhouse gas emissions have stimulated the demand for battery electric and (plug in) hybrid electric vehicles with increasing battery capacities. The electrical systems inside these vehicles work on higher voltages than conventional internal combustion engines. Control units in these vehicle electronics contain several polymer capacitors.

Polymer hybrid aluminum-electrolytic capacitors are often applied in this field. These capacitors consist of an etched Al/Al₂O₃ foil which serves as the electrode and the dielectric layer, covered by a conductive polymer layer which functions as the other electrode. Poly(3,4-ethylenedioxythiophene):poly(styrene sulfonate) (PEDOT/PSS) is commonly used, a conductive polymer complex which is coated on the Al/Al₂O₃ substrate by dip-coating from an aqueous formulation.

An important aspect of the manufacturing of these capacitors is the penetration of the conductive polymer particles in the Al/Al₂O₃ foil. To increase the surface area an etched foil of Al is used, which is then anodized to provide a thin layer of Al₂O₃. This process creates a porous Al/Al₂O₃ substrate, which is dip-coated with the aqueous PEDOT/PSS dispersion. The particle size of the conductive polymer particles therefore determines the ability of the polymer to penetrate the pores of the Al/Al₂O₃ substrate. Consequently, a lower particle size of the conductive polymer dispersion results in a better coating and in a lower equivalent series resistance (ESR) of the capacitor. In addition, lowering the surface resistance of the PEDOT/PSS layers decreases the ESR and improves the capacity.

Therefore, developing a PEDOT/PSS dispersion with a lower particle size and lower surface resistance of the coated layers can improve the characteristics of polymer capacitors. By using better-defined PSS within a specific molecular weight range and low polydispersity this goal can be achieved.

The synthesis of poly(styrene sulfonate) (PSS) is described by Tosoh in a number of patent applications, such as for example JP5760326, WO2014061357 and JP2020158574. However, these patent applications do not disclose the preparation of for example PEDOT in the presence of the disclosed poly(styrene sulfonate) s. WO201373259 disclose the preparation of PEDOT/PSS using high-purity parastyrene sulfonate. However, these PEDOT/PSS dispersions are not used to prepare polymer capacitors.

Balding et al. (Balding, P., Cueto, R., Russo, P. S. and Gutekunst, W. R. (2019), “Synthesis of perfectly sulfonated sodium polystyrene sulfonate over a wide molar mass range via reversible-deactivation radical polymerization”, J. Polym. Sci. Part A: Polym. Chem., 57:1527-1537) report on the polymerization of polystyrene sulfonate with atom transfer radical polymerization (ATRP) from parastyrene sulfonate. The paper shows the synthesis of polymers with a weight-average molecular weight of 23 to 480 kDa and a polydispersity of 1.06 to 1.29. However, the preparation of PEDOT:PSS with such polystyrene sulfonates is not reported.

### SUMMARY OF THE INVENTION

It is an object of the invention to provide a method of preparing a conductive polymer capacitor having a lower equivalent surface resistance (ESR) and a higher capacitance.

The object of the invention is realized by the method of preparing a conductive polymer capacitor as defined in claim 1.

Another object of the invention is a conductive polymer formulation for the method of preparing a conductive polymer capacitor.

Further objects of the invention will become apparent from the description hereinafter.

### DETAILED DESCRIPTION OF THE INVENTION

### Definitions

The term “monofunctional” in e.g. monofunctional polymerizable compound means that the polymerizable compound includes one polymerizable group.

The term “difunctional” in e.g. difunctional polymerizable compound means that the polymerizable compound includes two polymerizable groups.

The term “polyfunctional” in e.g. polyfunctional polymerizable compound means that the polymerizable compound includes more than two polymerizable groups.

The term “alkyl” means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted alkaryl group is preferably a phenyl or naphthyl group including one, two, three or more C₁ to C₆-alkyl groups.

Unless otherwise specified a substituted or unsubstituted aralkyl group is preferably a C₂ to C₂₀-alkyl group including a phenyl group or naphthyl group.

Unless otherwise specified a substituted or unsubstituted aryl group is preferably a phenyl group or naphthyl group.

Unless otherwise specified a substituted or unsubstituted heteroaryl group is preferably a five- or six-membered ring substituted by one, two or three oxygen atoms, nitrogen atoms, sulphur atoms, selenium atoms or combinations thereof.

Unless otherwise specified a substituted or unsubstituted alkylene group is preferably a C₁ to C₆-alkylene group.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

Unless otherwise specified a substituted alkyl group, a substituted alkenyl group, a substituted alkynyl group, a substituted aralkyl group, a substituted alkaryl group, a substituted aryl and a substituted heteroaryl group are preferably substituted by one or more constituents selected from the group consisting of methyl, ethyl, n-propyl, isopropyl, n-butyl, isobutyl and tertiary-butyl, ester, amide, amine, ether, thioether, ketone, aldehyde, sulfoxide, sulfone, sulfonate ester, sulphonamide, —Cl, —Br, —I, —OH, —SH, —CN and —NO₂.

### Polymer Capacitor

A polymer capacitor, also referred to as a polymer electrolyte capacitor, is an electrolytic capacitor comprising a solid conductive polymer electrolyte.

Electrolytic capacitors use a chemical feature of some special metals, often referred to as so-called valve metals, that by anodic oxidation form an insulating oxide layer. By applying a positive voltage to the anode material in an electrolytic bath an oxide barrier layer with a thickness corresponding to the applied voltage may be formed. This oxide layer acts as the dielectric in the electrolytic capacitor. To increase the capacitors capacitance the anode surface is roughened and so the oxide layer surface also is roughened.

To complete the capacitor, a counter electrode has to match the rough insulating oxide surface. This is accomplished by the electrolyte, which acts as the cathode electrode of an electrolytic capacitor. In a polymer electrolyte capacitor, this counter electrode consists of one or more layers of a conductive polymer, preferably a polythiophene conductive polymer.

The main difference between the polymer capacitors is the anode material and its oxide used as the dielectric:
Polymer tantalum electrolytic capacitors use high purity sintered tantalum powder as an anode with tantalum pentoxide (Ta₂O₅) as a dielectric; and
Polymer aluminium electrolytic capacitors use a high purity and electrochemically etched (roughened) aluminium foil as an anode with aluminium oxide (Al₂O₃) as the dielectric.

The porous metal layer (anode) covered with its oxide layer (dielectric) is referred to herein as a porous anode body.

### Method of Preparing Polymer Capacitor

The method of preparing the polymer capacitor according to the present invention comprises the step of introducing a conductive polymer formulation as described below into at least part of a porous anode body.

The polymer capacitor formulation may be introduced into the porous anode body by any known process such as impregnation, dipping, pouring, dripping on, spraying, misting on, knife coating, brushing or printing, for example ink-jet, screen or tampon printing.

Preferably, the polymer capacitor formulation is introduced into at least part of the porous anode body by dipping the body into the polymer capacitor formulation and thus impregnating it with the formulation.

The dipping into or the impregnation with the polymer capacitor formulation is preferably carried out for a period of from 1 second to 120 minutes, more preferably of from 5 seconds to 60 minutes, most preferably in a range of from 10 seconds to 15 minutes. The introduction of formulation into the anode body can be facilitated, for example, by increased or reduced pressure, vibration, ultrasound or heat.

After the porous anode bodies have been impregnated with polymer capacitor formulation, solvents contained in the formulation are preferably, at least partially, removed to obtain a solid electrolyte which completely or partly covers the dielectric thereby forming a capacitor body. The coverage of the dielectric by the solid electrolyte is preferably at least 10%, more preferably at least 25%, most preferably at least 50%. The coverage may be as is described in DE-A-10 2005 043 828.

The solvents are preferably removed by removing the electrode body from the formulation and drying it. The drying step is preferably carried out at a temperature of from 20° C. to 260° C., more preferably of from 50° C. to 220° C., most preferably of from 80° C. to 200° C.

The dipping and the drying step may be repeated once or several times to adapt the thickness of the solid electrolyte layer deposited on the dielectric or the degree of filling of the electrolyte in the electrode body to the particular requirements.

It may be advantageous to use both so-called self-doped and foreign-doped polythiophenes for the formation of the polymer cathode layer. A polythiophene typically has a positive charge located on the main chain of the polymer. The positive charge is preferably, at least partially, compensated by an anion. When the anion is covalently bound to the polymer, the polymer is then often referred to as a self-doped polymer or an intrinsically conductive polymer. The monomers used to make such self-doped polymers, i.e. comprising an anionic group, are also referred to as self-doped monomers.

When the anion is a separate compound, the polymer is then typically referred to as a foreign-doped polymer or an extrinsically conductive polymer. Anions added as separate compounds are preferably polyanions.

Both types of polythiophene polymers may be combined in a single polymer capacitor formulation and introduced as described above. However, it is preferred that both types of polythiopenes are introduced in the capacitor using different polymer capacitor formulations each comprising a self-doped or a foreign-doped polythiophene. Preferably, first a self-doped polythiopene is introduced into the porous anode body followed by the introduction of the foreign-doped polythiophene. Using both self-doped and foreign-doped polythiophenes is disclosed in for example WO2014/048562 (Heraeus) and US2016/0351338 (AVX).

After the capacitor bodies have been produced in this manner, they can be further modified by the method and manner known to the person skilled in the art. In the case of a tantalum electrolytic capacitor, the capacitor bodies can be covered, for example, with a polymeric outer layer, as is described in DE-A-10 2004 022674 or DE-A-10 2009 007 594, and/or a graphite layer and a silver layer, as is known from DE-A-10 2005 043 828, while in the case of an aluminium wound capacitor, in accordance with the teaching of U.S. Pat. No. 749,879, the capacitor body is incorporated into an aluminium beaker, provided with a sealing glass and firmly closed mechanically by crimping. The capacitor can then be freed from defects in the dielectric in a known manner by ageing.

### Conductive Polymer Formulation

A conductive polymer formulation is typically prepared from a conductive polymer dispersion by adding various additives to the conductive polymer dispersion. The conductive polymer formulation used in the method of preparing a polymer capacitor according to the present invention is prepared from the conductive polymer dispersion described below.

### Conductive Polymer Dispersion

A dispersion comprising a conductive polymer is referred to herein as a conductive polymer dispersion.

The conductive dispersion according to the present invention includes a conductive polymer and a polyanion, both as described below.

A dispersion medium of the conductive polymer dispersion is preferably selected from water, a water-soluble organic solvent, or mixtures thereof. Preferred organic solvents are protic organic solvents, such as alcohols or acids. The dispersion medium is preferably water.

The conductive polymer dispersion may comprise other ingredients such as dispersing agents.

The conductive polymer dispersion is preferably prepared as described below.

The median particle size (d₅₀) of the polythiophene/polyanion particles is preferably from 1 to 100 nm, more preferably from 2 to 75 nm, most preferably from 5 to 50 nm, particularly preferred from 10 to 40 nm. The d₅₀ particle size is preferably measured by centrifugal liquid sedimentation particle size analysis.

### Conductive Polymer

The conductive polymer according to the present invention is an oligo- or polythiophene obtained by the polymerization of a monomer according to Formula I,

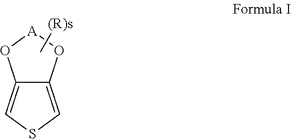

wherein
A represents a substituted or unsubstituted C₁ to C₈ alkylene bridge;
R is selected from the group consisting of a linear or branched substituted or unsubstituted C₁-C₁₈-alkyl group, a substituted or unsubstituted C₅-C₁₂ cycloalkyl group, a substituted or unsubstituted C₆-C₁₄-aryl group, a substituted or unsubstituted C₇-C₁₈-aralkyl group, a substituted or unsubstituted C₁-C₄-hydroxyalkyl group and a hydroxyl group;
s represents an integer from 0 to 8.

The term C₁ to C₈ alkylene bridge as used in Formula I means an alkylene bridge comprising 1 to 5 carbon atoms.

The C₁ to C₈ alkylene bridge is preferably methylene, ethylene, n-propylene, n-butylene or n-pentylene.

A C₁-C₁₈-alkyl radical includes linear or branched C₁-C₁₈-alkyl radicals, such as methyl, ethyl, n- or isopropyl, n-, iso-, sec- or tert-butyl, n-pentyl, 1-methyl-butyl, 2-methylbutyl, 3-methylbutyl, 1-ethylpropyl, 1,1-dimethylpropyl, 1,2-di-methylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl.

A C₅-C₁₂-cycloalkyl radical represents, for example, cyclopentyl, cyclohexyl, cycloheptyl, cyclooctyl, cyclononyl or cyclodecyl.

A C₆-C₁₄-aryl radical represents, for example, phenyl or naphthyl.

A C₇-C₁₈-aralkyl radical represent, for example, benzyl, o-, m-, p-tolyl, 2,3-, 2,4-, 2,5-,2,6-, 3,4-, 3,5-xylyl or mesityl.

Preferred substituents are alkyl, cycloalkyl, aryl, aralkyl, alkoxy, halogen, ether, thioether, disulphide, sulphoxide, sulphone, sulphonate, amino, aldehyde, keto, carboxylic acid ester, carboxylic acid, carbonate, carboxylate, cyano, alkylsilane and alkoxysilane groups and carboxamide groups.

A in Formula I is preferably an ethylene bridge.

In a particular preferred embodiment, the monomer according to Formula I is 3,4-ethylenedioxythiophene (EDOT).

The conductive polymer may be a homopolymer or a copolymer.

The conductive polymer is preferably poly(3,4-ethylenedioxythiophene) (PEDOT).

### Polyanion

The polymeric polyanion comprises at least one monomeric unit according to Formula II,

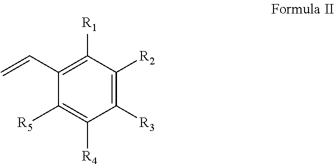

wherein
any of R₁ to R₅ is selected from the group consisting of a hydrogen, a halogen, an ether and substituted or unsubstituted alkyl group with the proviso that at least one of R₁ to R₅ is represented by a substituent according to Formula III,

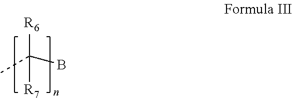

wherein
n represents 0 or 1,
R₆ and R₇ are independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group, R₆ and R₇ may represent the necessary atoms to form a five to eight membered ring,
B represents a functional group selected from the group consisting of a sulfonic acid or salt thereof, a sulfate ester or salt thereof and a carboxylic acid or salt thereof,
the dashed line represents the covalent bond to the styrene ring;
characterized in that the polydispersity of the polymeric polyanion is 3 or lower and a weight average molecular weight (Mw) of 25 to 175 kDa.

In a preferred embodiment, R₆ and R₇ are preferably independently selected from the group consisting of a hydrogen and a substituted or unsubstituted alkyl group, a hydrogen being the most preferred.

In an even further preferred embodiment, n represents 0.

In another preferred embodiment, only one of R₁ to R₅ represents a substituent according to Formula III. In a particularly preferred embodiment, one of R₂, R₃ and R₄ represents a substituent according to Formula III. In a further particularly preferred embodiment, all substituents, not representing a substituent according to Formula III, represent a hydrogen.

The polymeric polyanion can be a copolymer of different monomers according to Formula II but is preferably a homopolymer.

The polymeric polyanion preferably comprises at least 80 mol % of a monomeric unit according to Formula II, more preferably at least 90 mol % and most preferably the polymeric polyanion is fully comprised of monomeric units according to Formula II.

The polymeric polyanion is functionalized with a sulfonic acid or salt thereof.

In a particular preferred embodiment, the polymeric polyanion is poly(4-styrenesulfonic acid) or a salt thereof.

The polydispersity of the polymeric anion is 3 or lower, preferably 2.5 or lower, more preferably 2 or lower.

The weight average molecular weight of the polymeric anion is from 25 to 175 kDa, preferably from 30 to 150 kDa, more preferably from 35 to 100 kDa, most preferably from 40 to 90 kDa and particularly preferably from 50 to 80 kDa.

The polymeric polyanion is preferably prepared by a radical polymerization technique, more preferably by a controlled radical polymerization technique. A particular preferred controlled radical polymerization technique is Atom Transfer Radical Polymerization (ATRP). ATRP enables a better optimalization of the polydispersity and the Molecular Weight (Mw) of the obtained polymeric polyanion.

Typically five important components are used in ATRP: a monomer, an initiator, a catalyst, a ligand and a solvent.

The monomers are those according to Formula II.

Examples of monomers according to Formula II, without being limited thereto, are disclosed in Table 1.

TABLE 1

| | |
|---|---|
| 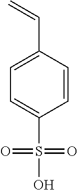 | Monomer-I |
| 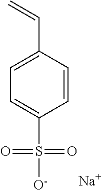 | Monomer-II |
| 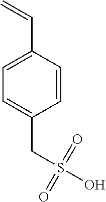 | Monomer-III |
| 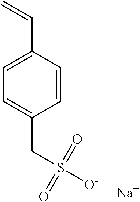 | Monomer-IV |
| 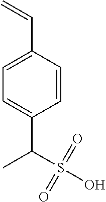 | Monomer-V |
| 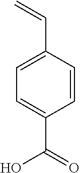 | Monomer-VI |
| 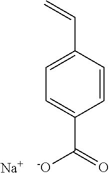 | Monomer-VII |
| 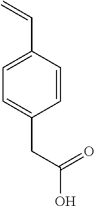 | Monomer-VIII |
| 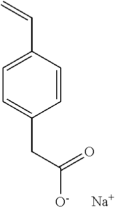 | Monomer-IX |

Suitable initiators are water-soluble organohalides such as 4-(bromomethyl)benzoic acid or 2-hydroxyethyl 2-bromoisobutyrate. Preferably 4-(bromomethyl)benzoic acid is used.

Suitable catalysts are transition-metal complexes, preferably copper salts. More preferably copper halides are used. Most preferably, CuCl or CuBr is used.

Suitable ligands are nitrogen-containing organic ligands such as 2,2-bipyridine, tris(2-dimethylaminoethyl)amine or N,N,N′,N′,N″-pentamethyl-diethylenetriamine. Preferably 2,2-bipyridine or tris(2-dimethyl-aminoethyl)amine is used. Most preferably 2,2-bipyridine is used.

Suitable solvents are water or a mixture of water and a water-soluble organic solvent, such as methanol, ethanol, propanol, butanol, dimethylformamide or dimethylsulfoxide. Preferably a water/methanol mixture is used, more preferably a ratio of 80/20 v/v % to 20/80 v/v % water/methanol and most preferably a ratio of 60/40 v/v % to 40/60 v/v % water/methanol.

The ATRP polymerization reaction is carried out with a specific molar ratios of the monomer, initiator, catalyst and ligand components. The ratio of monomer and initiator is preferably 70/1 to 500/1, more preferably 135/1 to 444/1 and most preferably 222/1. The ratio of catalyst to ligand is preferably 1/3. The ratio of initiator to catalyst is preferably between 2/1 and 1/2, more preferably between 2/1 and 1/1 and most preferably 2/1.

The temperature of the reaction mixture is preferably 5 to 100° C., more preferably 10 to 70° C., most preferably 20 to 55° C.

The concentration of the reaction, expressed in the amount of monomer per solvent (g/mL), is preferably 0.059 g/mL to 0.178 g/mL, more preferably 0.071 g/mL to 0.178 g/mL and most preferably 0.089 g/mL to 0.178 g/mL.

The duration of the reaction is preferably 3 to 24 hours.

To adjust the pH, an acid or base may be used. Preferably aqueous solutions of inorganic acids or bases are used. Preferably hydrochloric acid or sodium hydroxide is used.

### Preparation of the Conductive Polymer

The polythiophene conductive polymer is preferably prepared by oxidative polymerization of the thiophene monomers described above. More preferably, the conductive polymer is prepared by oxidative polymerization of the thiophene monomers described above in an aqueous medium.

The oxidative polymerization is preferably carried out in the presence of the polyanion described above.

The concentration of the thiophene monomer in the aqueous phase medium is preferably in a range from 0.1 to 25 wt %, preferably in a range from 0.5 to 10 wt %, all relative to the total weight of the aqueous reaction medium.

Suitable oxidizing agents are iron(III) salts, such as FeCl₃, and iron(III) salts of aromatic and aliphatic sulfonic acids; H₂O₂; K₂Cr₂O₇; KMnO₄, alkali metal perborates; alkali metal or ammonium persulfates; and mixtures thereof.

Further suitable oxidants are described, for example, in Handbook of Conducting Polymers (Ed. Skotheim, T. A., Marcel Dekker: New York, 1986, Vol. 1, pages 46-57).

Particularly preferred oxidizing agents are salts of a peroxydisulfate, in particular K₂S₂O₈, Na₂S₂O₈; iron(III) salts, in particular iron(III) chloride; or a combination thereof.

A mixture of salts of a peroxydisulfate and at least one further compound that catalyzes the cleavage of the peroxydisulfate, such as an Fe(III) salt, is particular preferred.

According to a particularly preferred embodiment the oxidizing agent is a mixture of Fe₂(SO₄)₃ and Na₂S₂O₈.

There are different ways for preparing the aqueous reaction medium. The thiophene monomer can be dissolved or dispersed in the aqueous reaction medium followed by the addition of the oxidizing agent(s), which can also be dissolved or dispersed in an aqueous phase, or the oxidizing agent(s) is/are first dissolved or dispersed in the aqueous reaction medium, followed by the addition of the thiophene monomer, which can also be dissolved or dispersed in an aqueous phase.

If more than one oxidizing agent is used, for example a mixture of Fe₂(SO₄)₃ and Na₂S₂O₈, it is furthermore possible to first mix one of these components with the thiophene monomer in the aqueous reaction medium followed by the addition of the second oxidizing agent.

The oxidative polymerization is preferably carried out under an inert atmosphere as disclosed in EP-11453877 (Agfa Gevaert). The oxygen content of the reaction medium when the oxidizing agent, for example a salt of peroxydisulfate, is added to it is preferably less than 3 mg per liter, more preferably less than 1.5 mg/liter, most preferably less than 0.5 mg/liter.

The concentration of oxygen in the reaction medium can be regulated by any means, such as freeze-thaw techniques, prolonged bubbling of an inert gas such as Argon, Nitrogen or Helium through the reaction medium, consumption of oxygen in a sacrificial reaction under an inert gas blanket. An inert gas is preferably bubbled through the reaction medium until the polymerization is completed thereby maintaining the oxygen concentration below 3 mg/l.

The oxidative polymerization is preferably carried out at low pH, as disclosed in EP-A 1384739 (Heraeus). The pH is preferably 1.5 or less, more preferably 1.00 or less.

To adjust the pH, an acid may be used, preferably selected from the group of water-soluble inorganic acids and water-soluble organic acids. Examples of inorganic acids are hydrochloric acid, sulfuric acid, nitric acid and phosphoric acid. Examples of organic acids include p-toluenesulfonic acid, benzenesulfonic acid, methanesulfonic acid and trifluoromethanesulfonic acid.

The temperature of the reaction mixture is preferably between 0 to 100° C., more preferably between 0 to 50° C., most preferably between 5 and 30° C.

The amount of thiophene monomers and polyanions in the reaction mixture are chosen so that stable polythiophene/polyanion dispersions are obtained of which the solid content is preferably from 0.05 to 25 wt %, more preferably from 0.1 to 10 wt %, most preferably from 0.8 to 2 wt %.

After the polymerization reaction is completed the liquid composition may be further purified, for example by means of filtration, in particular by means of ultrafiltration, and/or by a treatment with ion exchanger, in particular by a treatment with an anion exchanger and a cation exchanger.

After the purification step, the conductive polymer dispersion may be further optimized for the application wherein it will be used. For example, when used for preparing an antistatic layer, a liquid formulation described below may be prepared from the conductive polymer dispersion.

Various homogenization techniques may be used during the preparation of the conductive polymer. The homogenizing techniques may be selected from:
ultrasonic homogenization techniques;
pressure homogenization techniques; and
mechanical homogenization techniques.

Preferred mechanical homogenizers are rotor-stator homogenizers and blade type homogenizers. Another mechanical homogenization technique may be the use of a spinning disk reactor.

Preferred high-pressure homogenizers, such as for example a Gaulin homogenizer or an Ariete homogenizer, force the dispersion through a very narrow channel or orifice under pressure. Another preferred high-pressure homogenizer is a microfluidizer.

Two or more homogenizers may be used in combination, preferably in a consecutive way.

The homogenization techniques may be used before, during and after the polymerization reaction. These homogenization techniques may also be used during the preparation of the liquid formulation described below.

### Conductive Polymer Formulation

Depending on the application wherein the conductive polymer dispersion is used additional ingredients may be added to the conductive polymer dispersion thereby forming a conductive polymer formulation optimized for the application.

For example when used to prepare a polymer capacitor, such a formulation may be referred to as a conductive polymer capacitor formulation.

In addition to the conductive polymer and the polyanion described above the formulation may comprise further additives such as surface-active substances, adhesion promoters, crosslinking agents, binders, conductivity increasing compounds, heat- and moisture-stability improving compounds, acidic compounds and alkaline compounds.

The surface-active compounds may be:
anionic surfactants such as alkylbenzenesulphonic acids and salts, paraffin sulphonates, alcohol sulphonates, ether sulphonates, sulphosuccinates, phosphate esters, alkyl ether carboxylic acids or carboxylates;
cationic surfactants such as quaternary alkylammonium salts;
nonionic surfactants such as linear alcohol ethoxylates, oxo alcohol ethoxylates, alkylphenol ethoxylates or alkyl polyglucosides; and
zwitterionic surfactants such as compounds comprising both a carboxylic acid group and a quaternary ammonium group, for example lauryl-N,N-(dimethyl-ammonio)-butyrate and lauryl-N,N-(dimethyl)-glycinebetaine; compounds comprising both a sulfuric acid group and quaternary ammonium group, for example 3-[(3-cholamido-propyl)dimethylammonio]-1-propane-sulfonate, 3-(4-tert-butyl-1-pyridinio)-1-propanesulfonate, 3-(1-pyridinio)-1-propanesulfonate and 3-(benzyl-dimethyl-ammonio) propanesulfonate; compounds comprising both a phosphoric acid group and a quaternary ammonium group, for example with hexadecyl phosphocholine; compounds comprising a quaternary ammonium group with an attached hydroxy group, for example lauryldimethylamine N-oxide; and phospholipids, which consist of a quaternary ammonium head coupled via a phosphate group and glycerol to two hydrophobic fatty acids.

Particularly preferred surfactants are the commercially available surfactants available under the trademarks Dynol® and Zonyl®.

Preferred adhesion promoters are organofunctional silanes or hydrolysates thereof such as 3-glycidoxypropyltrialkoxysilane, 3-amino-propyl-triethoxysilane, 3-mercaptopropyltrimethoxysilane, 3-methacryloxypropyl-trimethoxysilane, vinyltrimethoxysilane or octyltriethoxysilane.

Preferred crosslinking agents are melamine compounds, blocked isocyanates, functional silanes such as tetraethoxysilane, alkoxysilane hydrolysates, such as tetraethoxysilane, epoxysilanes such as 3-glycidoxy-propyltrialkoxysilane.

Preferred binders are polyurethanes, polyacrylates or polyolefins.

Preferred conductivity increasing compounds are:
compounds containing ether groups such as e.g. tetrahydrofuran;
compounds containing lactone groups such as γ-butyrolactone or γ-valero-lactone;
compounds containing amide or lactam groups such as caprolactam, N-methylcaprolactam, N, N-dimethylacetamide, N-methylacetamide, formamide, N, N-dimethylformamide (DMF), N-methyl-formamide, N-methyl-formanilide, N-methyl-2-pyrrolidone (NMP), N-octyl-pyrrolidone, 2-pyrrolidone, N-butyl-pyrrolidone, and N-hydroxyethyl-pyrrolidon;
sulphones and sulphoxides such as sulpholane (tetramethylene sulphone) or dimethylsulphoxide (DMSO);
sugar or sugar derivatives such as arabinose, saccharose, glucose, fructose or lactose;
di- or polyalcohols such as sorbitol, xylitol, mannitol, mannose, galactose, sorbose, gluconic acid or ethylene glycol, di- or tri (ethylene glycol), 1,1,1-trimethylol-propane, 1,3-propanediol, 1-,2-propane-diol, 1,5-pentanediol, 1,2,3-propanetriol, 1,2,4-butanetriol or 1,2,6-hexanetriol, aromatic di- or polyalcohols such as resorcinol.

Particularly preferred conductivity increasing compounds are selected from the groups consisting of N-methyl-pyrrolidinone, N-butyl-pyrrolidone, N-hydroxyethyl-pyrrolidone, DMSO, ethylene glycol and diethylene glycol.

Preferred stability improving compounds are gallic acid derivatives.

The polymer capacitor formulation may have a pH of from 1 to 14, more preferably a pH of from 1 to 8. For corrosion-sensitive dielectrics, such as aluminium oxides or niobium oxides, the polymer capacitor formulation preferably has a pH of from 2.5 to 8, in order not to damage the dielectric.

To adjust the pH bases or acids as described in WO2010/003874 on page 4, lines 13-32 are preferably used. These compounds do not impair the film formation of the polymer capacitor formulation and are not volatile at higher temperatures such as soldering temperatures. Preferred compounds are the bases 2-dimethylaminoethanol, 2,2′-iminodiethanol or 2,2′,2″-nitrilotriethanol and the acid polystyrenesulphonic acid.

The viscosity of the polymer capacitor formulation is typically optimized as function of the application method and may be between 1 and 1 000 mPa·s (measured with a rheometer at 20° C. and a shear rate of 100 s⁻¹). Preferably, the viscosity is from 5 to 500 mPa·s, more preferably between from 10 to 250 mPa·s. In the case of the production of aluminium wound capacitors the viscosity is preferably from 1 to 200 mPa·s while in the production of tantalum electrolytic capacitors or aluminium stacked capacitors the viscosity is preferably from 1 to 50 mPa·s.

The adjustment of the viscosity can, for example, be accomplished by adding appropriate rheology modifiers as a further additive.

The solids content of polymer capacitor formulation is preferably from 0.01 to 20 wt %, more preferably from 0.1 to 15 wt %, most preferably from 0.25 to 10 wt %, in each case based on the total weight of the formulation.

### EXAMPLES

### Materials

All materials used in the following examples were readily available from standard sources such as ALDRICH CHEMICAL Co. (Belgium) and ACROS (Belgium) unless otherwise specified. The water used was deionized water.

4-vinylbenzenesulfonic acid, sodium salt commercially available from TCI Europe (Belgium).

EDOT is 3,4-ethylenedioxythiophene commercially available from Heraeus.

INI-01 is 2,2′-Azobis [2-methyl-N-2-hydroxyethyl) propionamide] commercially available from Fujifilm (Belgium).

PSS-1 is an aqueous solution of polystyrenesulfonic acid having a Mw of 300 kDa prepared according to a method disclosed in Houben-Weyl, Methoden der organischen Chemie, Vol. E 20, Makromolekulaire Stoffe, Teil 2 (1987), page 1141.

Lewatit® MonoPlus M600 is a basic, gelular anion exchange resin commercially available from Lanxess AG.

Lewatit® MonoPlus S 108 H is an acidic, gelular cation exchange resin commercially available from Lanxess AG.

### Methods

### Molecular Weight Measurement

The molecular weight of the polymers was determined by gel permeation chromatography (GPC) on a Waters e2695 alliance with a 2998A PDA detector, calibrated with polystyrene sulfonate standards. The molecular weight distribution (polydispersity D) is calculated with Waters Empower 3.

### Viscosity Measurement

The viscosity was measured with a glass capillary viscometer.

### Surface Resistance Measurement

The surface resistance SER was measured at room temperature using a two point probe method.

### Particle Size Measurement

The median particle size (Φ) size was determined by centrifugal liquid sedimentation particle size analysis on a CPS instruments Model MOD DC24000 UHR Disc centrifuge.

### Capacitance Measurement

The capacitance of a capacitor was measured at 120 Hz at room temperature with a potentiostat.

### ESR Measurement

The equivalent series resistance (ESR) was measured at 100 kHz at room temperature with a potentiostat.

### Example 1: Preparation of Polyanion-01 (a) to Polyanion-01 (e)

### Preparation of Catalyst/Ligand Complex Solution

0.055 g of CuCl was dissolved in 50 ml of water and is degassed by nitrogen bubbling for 45 min. 0.25 g of 2,2-bipyridine was added as a smelt. The solution further degassed for 30 min. with nitrogen.

### Polyanion-01 (a)

8.80 g of 4-vinylbenzenesulfonic acid, sodium salt was dissolved in 57.86 mL of water and 41.09 mL of methanol. A 1 wt % solution of NaCl was prepared and added to the solution (0.06 mL). 4-(Bromomethyl)benzoic acid was added (41.4 mg) and the pH is modified to 12 with NaOH. The reaction mixture was degassed by nitrogen bubbling for 60 min. 9.09 g of the CuCl/2,2-bipyridine catalyst/ligand complex solution was added. The reaction mixture was stirred for 3 hours at 55° C. Then, the catalyst/ligand complex was filtered out of the reaction mixture by filtering over silica (washed with MeOH/water 20/80 v/v %). The filtrate was dialyzed with dialysis tubes with a cutoff point of 1000 Da under a water flow. The obtained product was treated twice with ion exchanger (123 g Lewatit® MonoPlus S 108 H, filtered and washed with 2×40 mL). This procedure yielded clear to slightly yellow solutions of Polyanion-01 (a) in water.

### Polyanion-01 (b)

A polymerization was carried out in the same manner as described for Polyanion-01 (a) except for using a catalyst/ligand complex solution with 79 mg of CuBr. 15.0 g of 4-vinylbenzenesulfonic acid, sodium salt which was dissolved in 49.3 ml of water and 35.0 mL of methanol. 0.1 mL of a 1 wt % NaCl solution was added and 70.5 mg of 4-(bromomethyl)benzoic acid. 16.71 g of the CuBr/2,2-bipyridine catalyst/ligand complex solution is added. The reaction was stirred at room temperature for 24 hours. 121 g of Lewatit® MonoPlus S 108 H was used and the ion exchanger was washed with 2×40 ml of water.

### Polyanion-01 (c)

A polymerization was carried out in the same manner as described for Polyanion-01 (b) except for using 169 mL of water as solvent. 115 g of Lewatit® MonoPlus S 108 H was used and the ion exchanger is washed with 2×40 mL of water.

### Polyanion-01 (d)

A polymerization was carried out in the same manner as described for Polyanion-01 (b) except for using 4.00 g of 4-vinylbenzenesulfonic acid, sodium salt, 52.9 mg of 4-(bromomethyl)benzoic acid and 0.07 mL of a 1 wt % NaCl solution. 70 g of Lewatit® MonoPlus S 108 H was used and the ion exchanger was washed with 2×30 mL of water.

### Polyanion-01 (e)

A polymerization was carried out in the same manner as described for Polyanion-01 (d) except for using 35.2 mg of 4-(bromomethyl)benzoic acid, 0.05 mL of a 1 wt % NaCl solution and 8.36 g of the CuBr/2,2-bipyridine catalyst/ligand complex solution. 80 g of Lewatit® MonoPlus S 108 H was used and the ion exchanger was washed with 2×30 ml of water.

### Example 2

### Synthesis of Monomer-IV ((4-Vinylphenyl) Methanesulfonate, Sodium Salt)

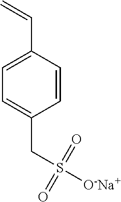

Sodium sulfite (22.72 g, 180 mmol) and 2,6-di-tert-butyl-4-methylphenol (0.79 g, 4 mmol) were dissolved in 144 mL water, blanketed by nitrogen. A solution of 1-(chloromethyl)-4-vinyl-benzene (20.35 g, 120 mmol) in acetone (114 mL) was added to the stirring reaction mixture. Next, the reaction mixture was refluxed for 6 hours. Afterwards, the reaction was cooled down to room temperature. The formed precipitate was filtered and washed with ethanol. The filtrate was concentrated in vacuo.

Both fractions were recrystallized in water/isopropanol (0.75/0.25), filtered and washed with acetone to obtain (4-vinylphenyl) methanesulfonate, sodium salt (23.4 g, 88.6%) as a white powder.

### Example 3: Preparation of Polyanion-02 (a) to Polyanion-02 (b)

### Polyanion-02 (a)

0.20 g of CuCl is dissolved in 49 ml of water and is degassed by nitrogen bubbling for 45 min. 0.95 g of 2,2-bipyridine is added. The mixture is heated to 50° C. to dissolve the products. The solution further degassed for 2 hours with nitrogen.

10.0 g of 4-vinylbenzenesulfonic acid, sodium salt is dissolved in 122.36 mL of water and 37.49 mL of methanol. A 1 wt % solution of NaCl is prepared and added to the solution (0.14 mL). 4-(Bromomethyl)benzoic acid is added (41.6 mg). The reaction mixture is degassed by nitrogen bubbling for 60 min. 6.64 g of the CuCl/2,2-bipyridine catalyst/ligand complex solution is added. The reaction mixture is stirred for 4 hours at 22.5° C. Then, an aqueous sulfuric acid solution (6N, 15.1 mL) is added while stirring. The product is dialyzed with dialysis tubes with a cutoff point of 1000 Da under a water flow. This procedure yielded clear to slightly yellow solutions of Polyanion-02 (a) in water.

### Polyanion-02 (b)

0.21 g of CuCl is dissolved in 200 ml of water and is degassed by nitrogen bubbling for 45 min. 1.0 g of a 1.4 wt % 2,2-bipyridine solution in water is added. The solution further degassed for 30 min. with nitrogen.

8.80 g of 4-vinylbenzenesulfonic acid, sodium salt is dissolved in 99 ml of water. A 1 wt % solution of NaCl is prepared and added to the solution (0.05 mL). 4-(Bromomethyl)benzoic acid is added (42.2 mg) and the pH is modified to 6 with HCl. The reaction mixture is degassed by nitrogen bubbling for 60 min. 8.51 g of the CuCl/2,2-bipyridine catalyst/ligand complex solution is added. The reaction mixture is stirred for 3 hours at room temperature. Then, the catalyst/ligand complex is filtered out of the reaction mixture by filtering over alumina (washed with MeOH/water 20/80 v/v %). The filtrate is dialyzed with dialysis tubes with a cutoff point of 1000 Da under a water flow. The product is freeze-dried and redissolved in 100 ml of water. The obtained solution is treated twice with ion exchanger (115 g Lewatit® MonoPlus S 108 H, filtered and washed with 2×50 mL). This procedure yielded clear to slightly yellow solutions of Polyanion-01 (b) in water.

### Comparative Example 1: Free Radical Polymerization of Monomer-IV

5.22 g of Monomer-IV (4-vinylphenyl) methanesulfonate, sodium salt) obtained in Example 1 was dissolved in 77.73 mL of water. The reaction mixture was stirred and heated to 90° C.

A 2.00 wt % solution of INI-01 in water was prepared and degassed with nitrogen for 1 hour. An amount of the initiator solution was added rapidly to the reaction mixture to result in an initiator concentration of 3.33 mol %. The solution was stirred for 20 hours at 90° C.

Then, the reaction mixture was treated twice with ion exchanger (30 g Lewatit® MonoPlus S 108 H, filtered and washed with 2×20 mL water).

This procedure yielded clear to slightly yellow solutions of Polyanion-02 (c).

### Example 4

The Molecular Weight (Mw) in kDa of Polyanion-01 (a) to Polyanion-01 (e) and PSS-1 and their polydispersity D was determined as described above. The results are shown in Table 2.

TABLE 2

| | Mw | | Conc. |
|---|---|---|---|
| | (kDa) | D | (wt %) |
| Polyanion-01(a) | 70 | 1.68 | 1.73 |
| Polyanion-01(b) | 67 | 1.43 | 1.83 |
| Polyanion-01(c) | 166 | 2.29 | 1.62 |
| Polyanion-01(d) | 75 | 1.78 | 1.47 |
| Polyanion-01(e) | 132 | 1.66 | 1.61 |
| Polyanion-02(a) | 168 | 2.91 | 1.17 |
| Polyanion-02(b) | 139 | 1.91 | 2.42 |
| Polyanion-02(c) | 221 | 8.23 | 2.40 |
| PSS-1 | 157 | 3.81 | 5.80 |

### Example 5: Preparation of PEDOT/Polyanion-01 (a)

216.8 g of Polyanion-01 (a) obtained in Example 1, deionized water (132 mL), nitric acid (3.80 g) were mixed in a reaction vessel. Iron (III) sulfate (0.14 g) and sodium persulfate (2.77 g) were added. The reaction mixture was stirred and cooled to 5° C. under nitrogen flow for 90 min. The oxygen level was below 30 ppb. 3,4-Ethylenedioxythiophene (EDOT) (1.50 g) was added to the reaction mixture and stirred for 20 hours at 5° C. under nitrogen. The reaction mixture was treated with ion exchanger (100 g Lewatit® MonoPlus M600+50 g Lewatit® MonoPlus S 108 H, filtered and washed 3×50 mL water, repeated). The resulting viscous mixture was treated with high shear homogenization (Lab Gaulin, 4×600 bar). The dispersion was concentrated in vacuo. This procedure yielded a blue dispersion of PEDOT/Polyanion-01 (a) in water (1.50 wt %).

### Example 6: Preparation of PEDOT/Polyanion-01 (b)

A polymerization was carried out in the same manner as in Example 5 except for using 204.9 g of Polyanion-01 (b) obtained in Example 1 and 144 mL of deionized water. The reaction mixture was treated with ion exchanger (95 g Lewatit® MonoPlus M600+50 g Lewatit® MonoPlus S 108 H, filtered and washed 3×50 mL water, repeated). This procedure yielded a blue dispersion of PEDOT/Polyanion-01 (b) in water (1.37 wt %).

### Example 7: Preparation of PEDOT/Polyanion-01 (c)

A polymerization was carried out in the same manner as in Example 6 except for using 231.5 g of Polyanion-01 (c) obtained in Example 1 and 117 mL of deionized water. This procedure yielded a blue dispersion of PEDOT/Polyanion-01 (c) in water (1.38 wt %).

### Example 8: Preparation of PEDOT/Polyanion-01 (d)

A polymerization was carried out in the same manner as in Example 6 except for using 255.1 g of Polyanion-01 (d) obtained in Example 1 and 93.4 mL of deionized water. This procedure yielded a blue dispersion of PEDOT/Polyanion-01 (d) in water (1.31 wt %).

### Example 9: Preparation of PEDOT/Polyanion-01 (e)

A polymerization was carried out in the same manner as in Example 6 except for using 232.9 g of Polyanion-01 (e) obtained in Example 1 and 115.6 mL of deionized water. This procedure yielded a blue dispersion of PEDOT/Polyanion-01 (e) in water (1.26 wt %).

### Example 10: Preparation of PEDOT/Polyanion-02 (a)

A polymerization was carried out in the same manner as in Example 5 except for using 126.3 g of Polyanion-02 (a) obtained in Example 3, 152.6 mL of deionized water, 2.9 g of nitric acid, 0.10 g of iron(III) sulfate, 2.11 g of sodium persulfate and 1.14 g of EDOT. The reaction mixture was treated with ion exchanger (75 g Lewatit® MonoPlus M600+40 g Lewatit® MonoPlus S 108 H, filtered and washed 2×50 mL water, repeated). This procedure yielded a blue dispersion of PEDOT/Polyanion-02 (a) in water (1.26 wt %).

### Example 11: Preparation of PEDOT/Polyanion-02 (b)

A polymerization was carried out in the same manner as in Example 5 except for using 279.8 g of Polyanion-02 (b) obtained in Example 3, 18.9 mL of deionized water, 3.11 g of nitric acid, 0.11 g of iron(III) sulfate, 2.26 g of sodium persulfate and 1.23 g of EDOT. The reaction mixture was treated with ion exchanger (80 g Lewatit® MonoPlus M600+45 g Lewatit® MonoPlus S 108 H, filtered and washed 2×70 mL water, repeated). This procedure yielded a blue dispersion of PEDOT/Polyanion-02 (b) in water (1.41 wt %).

### Comparative Example 2: Polymerization of PEDOT: Polyanion-02 (c)

A polymerization was carried out in the same manner as in Example 6 except for using 172.8 g of Polyanion-02 (c) obtained in Example 3, 206 mL of deionized water, 3.9 g of nitric acid, 0.14 g of iron(III) sulfate, 2.86 g of sodium persulfate and 1.55 g of EDOT. The reaction mixture is treated with ion exchanger (100 g Lewatit® MonoPlus M600+55 g Lewatit® MonoPlus S 108 H, filtered and washed 2×50 mL water, repeated). This procedure yielded a blue dispersion of PEDOT/Polyanion-02 (c) in water (1.28 wt %).

### Comparative Example 3: Polymerization of PEDOT:PSS

88.7 g of PSS-1, deionized water (389 mL), and nitric acid (14.3 g) were mixed in a reaction vessel.

Iron (III) sulfate (0.094 g) and sodium persulfate (3.48 g) were added. The reaction mixture was stirred and cooled to 5° C. under nitrogen flow. The oxygen level was below 30 ppb. EDOT (2.06 g) was added to the reaction mixture and stirred for 20 hours at 5° C. The reaction mixture was then treated with ion exchanger (130 g Lewatit® MonoPlus M600+70 g Lewatit® MonoPlus S 108 H, filtered and washed 2×50 mL water, repeated). The resulting viscous mixture was treated with high shear homogenization (Lab Gaulin, 4×600 bar). After a concentration step in vacuo a 1.15 wt % blue dispersion of PEDOT/PSS-1 (a) in water was obtained.

### Example 12

The median particle size (Φ) and viscosity of the conductive PEDOT/PSS dispersions and the SER of bar-coated films of these dispersions on PET are shown in Table 3 together with the weight average Molecular Weight (Mw) and polydispersity (D) of the PSS used.

TABLE 3

| | Mw of | D of | Φ | Viscosity | SER |
|---|---|---|---|---|---|
| | PSS (kDa) | PSS | (nm) | (mPa · s) | (Ω/□) |
| PEDOT/Polyanion-01(a) | 70 | 1.68 | 25 | 99.8 | 44 |
| PEDOT/Polyanion-01(b) | 67 | 1.43 | 23 | 108.0 | 41 |
| PEDOT/Polyanion-01(c) | 166 | 2.29 | 31 | 228.0 | 46 |
| PEDOT/Polyanion-01(d) | 75 | 1.78 | 29 | 116.0 | 48 |
| PEDOT/ Polyanion-01(e) | 132 | 1.66 | 26 | 78.6 | 62 |
| PEDOT/Polyanion-02(a) | 168 | 2.91 | 20 | 61.0 | 68 |
| PEDOT/Polyanion-02(a) | 139 | 1.91 | 22 | 62.0 | 63 |
| PEDOT/Polyanion-02(a) | 221 | 8.23 | 24 | 93.2 | 88 |
| PEDOT/PSS-1 | 157 | 3.81 | 38 | 56.8 | 66 |

It is clear from the results in Table 3 that the dispersions wherein a polyanion according to the present invention is used, lower median particle sizes and lower SER values can be obtained.

### Example 13: Preparation of Capacitors

A chemically converted aluminum foil including an etching layer on a surface was prepared as a valve metal base. A dielectric layer was formed to cover the aluminum foil. The resulting chemically converted aluminum foil was used as an anode component. The rated voltage of the alumina layer is 90 V and the capacitance is 6.4 μF/cm². A 20 μm thick sold mask was printed on the Al foil with arrays of openings of 10 mm×10 mm. The patterned foil was cut to 30 mm×105 mm strips with 5 openings on them.

The conductive polymer dispersions used in the manufacturing of the capacitors were formulated with water, diethyleneglycol and DYNOL™ 604 and treated with an ultrasound homogenization step prior to coating of the aluminum foils.

The strip was dip-coated with PEDOT/Polyanion-01 (a) dispersion and dried at 150° C. for 5 minutes. The dip-coating and curing steps were repeated for several times. Then, carbon paste and silver paste were sequentially screen-printed on the PEDOT layer and cured. The capacitance and equivalent series resistance (ESR) were measured as described above.

Additional capacitors were prepared and measured as described above where PEDOT/Polyanion-01 (b), PEDOT/Polyanion-01 (c), PEDOT/Polyanion-01 (d), PEDOT/Polyanion-01 (e) and PEDOT/PSS-1 were used as conductive polymer dispersions.

In Table 4 the results of the capacitor evaluation are summarized.

TABLE 4

| | Capacitance | ESR |
|---|---|---|
| | (μF) | (mΩ) |
| PEDOT/Polyanion-01(a) | 5.7 | 27.4 |
| PEDOT/Polyanion-01(b) | 5.6 | 32.0 |
| PEDOT/Polyanion-01(c) | 5.6 | 24.4 |
| PEDOT/Polyanion-01(d) | 5.5 | 46.8 |
| PEDOT/Polyanion-01(e) | 5.9 | 37.3 |
| PEDOT/PSS-1(a) | 4.9 | 97.0 |

It is clear from the results in Table 4 that the dispersions wherein a polyanion according to the present invention is used, the capacitance of the capacitors is higher while the ESR is lower.

1-15. (canceled)

16. A method of preparing a polymer capacitor comprising a porous anode body including the step of introducing a conductive polymer formulation into at least part of the porous anode body,
the conductive polymer formulation comprising:
(a) at least one oligo- or polythiophene obtained by the polymerization of at least one monomer according to Formula I, 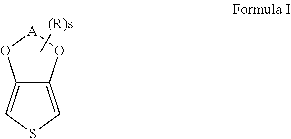
wherein
A represents a substituted or unsubstituted C1-C5 alkylene bridge;
R is selected from the group consisting of a linear or branched substituted or unsubstituted C1-C18 alkyl group, a substituted or unsubstituted C5-C12 cycloalkyl group, a substituted or unsubstituted C6-C14 aryl group, a substituted or unsubstituted C7-C18 aralkyl group, and a hydroxyl group; and
s represents an integer from 0 to 8, and
(b) a polymeric polyanion comprising at least one monomeric unit according to Formula II, 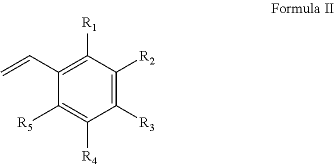
wherein
R₁ to R₅ are each independently selected from the group consisting of a hydrogen, a halogen, an ether, and substituted or unsubstituted alkyl group, with the proviso that at least one of R₁ to R₅ is represented by a substituent according to Formula III, 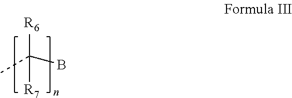
wherein
n represents 0 or 1;
R₆ and R₇ are each independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group, and a substituted or unsubstituted aryl or heteroaryl group, or R₆ and R₇ may represent the necessary atoms to form a five to eight membered ring;
B represents a functional group selected from the group consisting of a sulfonic acid or salt thereof, a sulfate ester or salt thereof, and a carboxylic acid or salt thereof; and
the dashed line represents the covalent bond to the styrene ring,
characterized in that the polymeric polyanion has a polydispersity of 3 or less and a weight average molecular weight (Mw) of 25 to 175 kDa.

17. The method of preparing a polymer capacitor of claim 16, wherein the polydispersity of the polyanion is 2 or less.

18. The method of preparing a polymer capacitor of claim 16, wherein the weight average molecular weight (Mw) of the polyanion is from 40 to 90 kDa.

19. The method of preparing a polymer capacitor of claim 17, wherein the weight average molecular weight (Mw) of the polyanion is from 40 to 90 kDa.

20. The method of preparing a polymer capacitor of claim 16, wherein the polymeric polyanion is poly(4-styrenesulfonic acid) or a salt thereof.

21. The method of preparing a polymer capacitor of claim 17, wherein the polymeric polyanion is poly(4-styrenesulfonic acid) or a salt thereof.

22. The method of preparing a polymer capacitor of claim 16, wherein the oligo- or polythiophene and the polyanion are present as polythiophene/polyanion particles having a median particle size (d₅₀) from 5 to 40 nm, measured by centrifugal liquid sedimentation particle size analysis.

23. The method of preparing a polymer capacitor of claim 17, wherein the oligo- or polythiophene and the polyanion are present as polythiophene/polyanion particles having a median particle size (d₅₀) from 5 to 40 nm, measured by centrifugal liquid sedimentation particle size analysis.

24. The method of preparing a polymer capacitor of claim 16, wherein the formulation has a pH from 2 to 8.5.

25. The method of preparing a polymer capacitor of claim 17, wherein the formulation has a pH from 2 to 8.5.

26. The method of preparing a polymer capacitor of claim 16, wherein the viscosity of the formulation is from 1 to 250 mPa·s measured with a rheometer at 20° C. and a shear rate of 100 s⁻¹.

27. The method of preparing a polymer capacitor of claim 17, wherein the viscosity of the formulation is from 1 to 250 mPa·s measured with a rheometer at 20° C. and a shear rate of 100 s⁻¹.

28. The method of preparing a polymer capacitor of claim 16, wherein the formulation further comprises a conductivity increasing compound selected from the group consisting of N-methyl-pyrrolidinone, N-butyl-pyrrolidone, N-ethyl-pyrrolidone, N-hydroxyethyl-pyrrolidone, DMSO, ethylene glycol, and diethylene glycol.

29. The method of preparing a polymer capacitor of claim 16, wherein the polyanion is prepared by Atom Transfer Radical Polymerization (ATRP).

30. A conductive polymer composition for a polymer capacitor comprising:
(a) at least one oligo- or polythiophene obtained by the polymerization of at least one monomer according to Formula I, 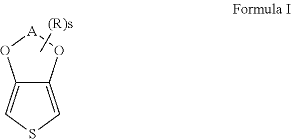
wherein
A represents a substituted or unsubstituted C1-C5 alkylene bridge;
R is selected from the group consisting of a linear or branched substituted or unsubstituted C1-C18 alkyl group, a substituted or unsubstituted C5-C12 cycloalkyl group, a substituted or unsubstituted C6-C14 aryl group, a substituted or unsubstituted C7-C18 aralkyl group, and a hydroxyl group; and
s represents an integer from 0 to 8, and
(b) a polymeric polyanion comprising at least one monomeric unit according to Formula II, 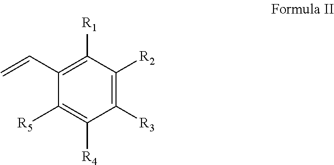
wherein
R₁ to R₅ are each independently selected from the group consisting of a hydrogen, a halogen, an ether, and substituted or unsubstituted alkyl group, with the proviso that at least one of R₁ to R₅ is represented by a substituent according to Formula III, 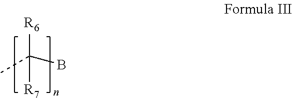
wherein
n represents 0 or 1;
R₆ and R₇ are each independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group, and a substituted or unsubstituted aryl or heteroaryl group, or R₆ and R₇ may represent the necessary atoms to form a five to eight membered ring;
B represents a functional group selected from the group consisting of a sulfonic acid or salt thereof, a sulfate ester or salt thereof, and a carboxylic acid or salt thereof; and
the dashed line represents the covalent bond to the styrene ring,
characterized in that the polymeric polyanion has a polydispersity of 3 or less and a weight average molecular weight (Mw) of 25 to 175 kDa.

31. The conductive polymer composition of claim 30, wherein the polydispersity of the polyanion is 2 or less.

32. The conductive polymer composition of claim 30, wherein the weight average molecular weight (Mw) of the polyanion is from 50 to 80 kDa.

33. The conductive polymer composition of claim 30, wherein the polyanion is prepared by Atom Transfer Radical Polymerization (ATRP).

34. An electronic device having a conductive layer or conductive circuitry obtained from a conductive polymer composition according to claim 30.

35. The electronic device of claim 34, selected from photoconductive cells, photoresistors, photoswitches, phototransistors, phototubes, IR detectors, photovoltaic device, solar cells, coating materials for memory storage devices, field effect resistance devices, anti-static films, biosensors, electrochromic devices, solid electrolyte capacitors, hybrid capacitors, super capacitors, energy storage devices, batteries, and electromagnetic shielding.
